(19) United States
(12) Patent Application Publication
(10) Pub. No.: US 2026/0350394 A1
(43) Pub. Date: Nov. 5, 2026

(54) METHOD AND DEVICE FOR TRAINING AN OBJECT DETECTOR WITH AN ENSEMBLE OF SEVERAL DETECTION HEADS

(71) Applicant: Robert Bosch GmbH, Stuttgart (DE)

(72) Inventors: Lukas Enderich, Berlin (DE); Simon Heming, Hannover (DE); Alexander Hirsch, Muenchen (DE)

(21) Appl. No.: 19/102,868

(22) PCT Filed: Sep. 7, 2023
(86) PCT No.: PCT/EP2023/074544

§ 371 Date: Feb. 11, 2025

(30) Foreign Application Priority Data
Sep. 12, 2022 (DE) 10 2022 209 517.0

(51) Int. Cl. G06N 3/082; G06V 10/25

(52) U.S. Cl. CPC G06N 3/082; G06V 10/25; G06V 2201/07

(57) ABSTRACT

A computer-implemented method for training a neural network. The neural network detects objects in images. The training includes: ascertaining a feature representation of a training image using a backbone of the neural network; ascertaining head outputs based on the feature representation and using heads of the neural network, wherein the head outputs, for regions of the training image, each characterize a presence or absence of an object or characterize an extension of the object or characterize a position of the object or characterize the extension and the position; ascertaining first loss values, wherein each first loss value corresponds to a head output and characterizes a deviation of the head output from a desired head output; adjusting a parameter(s) of the backbone and/or at least one parameter of a head based on a second loss value, wherein the second loss value characterizes a sum of the first loss values.

### FIELD

The present invention relates to a method for training a neural network, a method for executing the neural network, a device for training, a device for executing, a computer program, and a computer-readable storage medium.

### BACKGROUND INFORMATION

Tran et al., “Hydra: Preserving Ensemble Diversity for Model Distillation,” 2020, arxiv.org/pdf/2001.04694.pdf, describes an ensemble for image classification.
Zhuo et al., “Objects as Points,” 2019, arxiv.org/abs/1904.07850, describes CenterNet, a neural network architecture for object detection.
Liu et al., “SSD: Single Shot MultiBox Detector,” 2016, arxiv.org/abs/1512.02325, describes SSD, a neural network architecture for object detection.
Ren et al., “Faster R-CNN: Towards Real-Time Object Detection with Region Proposal Networks,” 2015, arxiv.org/abs/1506.01497, describes Faster R-CNN, a neural network architecture for object detection.

### BACKGROUND INFORMATION

Machine learning systems, in particular neural networks, are increasingly used in various areas of technology. These statistical methods have proven to be particularly suitable in cases where statements can no longer be extracted from data on a rule-based basis, or not with sufficient quality. In particular when detecting objects from digital images, methods from the field of machine learning currently allow for the best possible quality in terms of object detection.

In this context, ensemble methods have been shown to improve both the quality of the prediction and the quantification of the uncertainty in comparison to individual neural networks. Ensemble methods can, for example, consist of a plurality of neural networks trained independently of one another (deep ensemble). By calculating a plurality of in particular different predictions for the same input data, the variance of the predictions, among other things, can be used as an indicator of uncertainty regarding object detection. For example, if the different neural networks of a deep ensemble largely agree in their predictions, the uncertainty is rather low; if they do not, the uncertainty increases. The prediction quality is also improved by calculating the average value of the individual predictions.

However, this increase in prediction performance comes at the price of a greatly increased computational requirement. Typically, the need for computing capacity and memory grows linearly with the number of neural networks, which in today's neural networks, even with a small ensemble, can have the result that the ensemble can no longer be evaluated or can no longer be evaluated quickly enough, or that the memory requirement is too large for the executing computer. This poses a significant risk, in particular in safety-critical applications, since the objects in the images can no longer be ascertained quickly enough.

### SUMMARY

Advantageously, a neural network trained according to a method according to the present invention may make the advantages of object detection using an ensemble possible (more accurate predictions, more accurate uncertainty determination), while the computing time is only slightly increased. This allows the use of the neural network even in computer architectures that have to deal with very limited computing and storage capacities, such as embedded systems.

In a first aspect, the present invention relates to a computer-implemented method for training a neural network, wherein the neural network is designed to detect objects in images.

According to an example embodiment of the present invention, the training comprises the following steps:
ascertaining a feature representation of a training image by means of a backbone of the neural network;
ascertaining head outputs based on the feature representation and by means of a plurality of heads of the neural network, wherein the head outputs, for regions of the training image, in each case characterize a presence or absence of an object or characterize an extension of the object or characterize a position of the object or characterize the extension and the position;
ascertaining a plurality of first loss values, wherein a first loss value in each case corresponds to a head output and characterizes a deviation of the head output from a desired head output;
adjusting at least one parameter of the backbone and/or at least one parameter of a head based on a second loss value, wherein the second loss value characterizes a sum of the first loss values.

The fact that the neural network is designed to detect objects in images can be understood in particular as the neural network being designed to process an input image, wherein the input image comprises the image, in particular a digital image, and the neural network is further configured to ascertain an output signal which characterizes the presence or absence of objects within the image. In particular, the term “object detection” can thus be understood as the detection of the absence of an object.

The expression “object located in the image” or “object of an image” can be understood in particular to mean that the image depicts the object, i.e., there are a plurality of pixel values within the image that together represent the object. Typically, such objects are the mapping of a real-world object onto a digital image using a corresponding sensor. In particular, optical sensors, in particular a camera, can be used as sensors. However, images within the meaning of the present invention can also be recorded by other sensors, for example LIDAR, radar, an ultrasonic sensor, or a thermal camera.

Preferably, according to an example embodiment of the present invention, the output signal can also characterize a spatial extension of at least one object within the image and/or a positioning of the object within the image. As an alternative to spatial extension within the image and/or positioning within the image, the output signal can also characterize spatial extension with respect to real dimensions of the object in the real world and/or positioning within a real-world coordinate system. For example, intrinsic and extrinsic parameters of a camera can be used to assign a coordinate in a predefined real-world coordinate system to the pixels and thus objects of an image. The neural network can then be trained to determine the position and/or extension of the object with respect to the predefined coordinate system instead of the position and/or extension of the object with respect to a width and height of the image in pixels.

The neural network itself can be understood as consisting of two parts. The first part of the network comprises the backbone. The term “backbone” is commonly used in the related art. Occasionally, the terms “base” or “base network” are used synonymously with the term “backbone.” The backbone, sometimes also called feature extractor, can in turn be understood as a neural network. The task of the backbone is to transform the image into the feature representation on the basis of which object detection can then be carried out. Preferably, the feature representation is at least one three-dimensional tensor with one dimension each for width, height, and depth. In this case, along the depth dimension, there are feature vectors that characterize regions of the image, wherein the region of the image that the feature vector represents is indicated by the width and height dimensions of the tensor. The architecture of the backbone can follow common architectures for neural networks, in particular neural networks for images, for example residual networks (ResNets) or optical transformers (vision transformers or visual transformers).

The feature representation is processed by a second part of the neural network. This second part comprised so-called heads. The heads are each designed to ascertain, for regions of the training image, a head output which in each case characterizes a presence or absence of an object, or are each designed to characterize an extension of the object, or are each designed to characterize a position of the object, or are each designed to characterize the extension and the position. In addition to the presence or absence of an object, a class membership, determined by a head, of an object can also be provided in a head output. This is different from conventional neural networks since only one head is provided in conventional neural networks to predict the presence or absence of an object, or an extension of the object, or a position of the object, or the extension and the position. For example, in the conventional CenterNet architecture, there is one head for presence/absence determination, one head for position determination, and one head for determining the width and height of the object. In the conventional single shot detection (SSD) architecture, there are two heads, one of which performs the presence/absence determination and the other of which performs the position and extension determination. The structure of a Faster R-CNN is similar to that of SSD.

In contrast to these conventional architectures, the neural network presented in the present invention ascertains in each case a plurality of heads for ascertaining the presence/absence or for ascertaining the position or for ascertaining the extension or for ascertaining the extension and the position. The heads can therefore be understood as an ensemble designed to ascertain the presence/absence or position or extension or position and extension. The inventors found that the introduction of an ensemble leads to a significant increase in the accuracy of object detection.

Preferably, according to an example embodiment of the present invention, a head is itself a neural network. The neural network can therefore preferably consist of a plurality of subnetworks, namely the backbone and the heads. However, other models from the field of machine learning, for example support vector machines, are also possible as backbone and heads.

The heads of the plurality of heads each ascertain a head output. For training, these head outputs are each compared with a desired head output in order to ascertain a first loss value. This allows a first loss value to be ascertained for each head based on the head output of the head. This creates a one-to-one correspondence of each head with a first loss value. The first loss values thus ascertained can then be combined via a sum, for example a weighted sum, in particular an equally weighted sum, to form the second loss value. Based on the second loss value, the neural network can then be adapted during training, for example by means of a gradient descent of the parameters of the neural network in relation to the second loss value.

According to an example embodiment of the present invention, a head output is preferably given in the form of a matrix or a tensor.

For ascertaining the first loss values, the same desired head output can be compared with the head outputs ascertained in each case. In particular, in case the head outputs characterize a presence or absence of objects, a cross-entropy between a head output and the desired head output can be provided as a first loss value. For the other cases, an L₁ loss function can in particular be used to ascertain a first loss value.

In preferred further example embodiments of the present invention, it can also be provided that the second loss value characterizes a negative correlation in relation to the different head outputs.

According to an example embodiment of the present invention, the head outputs can in particular be in the form of matrices or tensors, wherein equal indices of different head outputs each characterize an equal part of the training image. For equal indices, a negative correlation of the values at the corresponding indices can then be ascertained in each case. The objective of the training can then be advantageously defined as ensuring that the values of the head outputs at equal indices have the highest possible negative correlation. However, a different metric which expresses a diversity between the head outputs and is thus to be maximized can also be used as a training objective.

This can be understood as a regularization of the head outputs. By regularizing the head outputs, the neural network learns to ascertain different head outputs with respect to a feature representation, wherein the sum of the first loss values allows the neural network to continue to learn to detect the objects correctly. This can be understood as balancing of two learning objectives: on the one hand, the objective of ascertaining head outputs that are as different as possible and, on the other hand, the objective of correctly detecting objects in the training image. The inventors found that the use of a negative correlation as regularization advantageously further increases the accuracy of the neural network.

Technically, all negative correlations of values of equal indices between the head outputs can be summed, or an average value can be ascertained from the negative correlations, wherein the sum or the average value is included as the above-described negative correlation in the second loss value. In particular, the negative correlation can be added as a term to the sum of the first loss values in order to ascertain the second loss value. Preferably, the negative correlation can be multiplied by a predefined value, which can be understood as a hyperparameter of the training.

In various preferred example embodiments of the present invention, a plurality of heads can also be provided in each case for determining the presence/absence, for determining the position, and for determining the extension. This can be understood to mean that, in the neural network, there is an ensemble each for determining the presence/absence, the position, and the extension, i.e., there is a plurality of pluralities of heads. The inventors found that, by using a plurality of pluralities of heads, the accuracy of the neural network can be increased even further.

In a further aspect, the present invention relates to an execution of the trained neural network, i.e., a method for ascertaining an output signal by means of the neural network. According to an example embodiment of the present invention, the method comprising the following steps:
ascertaining a feature representation of the image by means of the backbone of the neural network;
ascertaining a plurality of head outputs based on the feature representation and by means of the plurality of heads of the neural network;
ascertaining a combination of the plurality of head outputs into one head output;
ascertaining the output signal based on the one head output.

The steps for executing the neural network, i.e., the steps during the inference phase, are largely the same as the steps necessary to train the neural network. However, a key difference is in the ascertaining of the output signal. During training, the different head outputs were output so that each head output can be compared with a desired head output. At inference time, the head outputs ascertained by the plurality of heads are combined to form the one head output, and the output signal that characterizes an object detection of objects in the image is ascertained based on this combined head output.

Different methods can be chosen for the combining. In various embodiments of the present invention, it is possible that the head outputs are each equal in their form (for example, matrix or tensor) (for example, equal number of dimensions and of elements in each of the dimensions). This can be the case in particular if the individual heads are identical in their architecture (for example, the same number of layers with the same number of neurons) or if the last layers of the heads in each case are identical. In these preferred cases, the average values of elements at the same index positions of the head outputs can be used for the combining. Alternatively, it is also possible to choose a weighted sum instead of averaging, wherein the weights can be understood as hyperparameters of the neural network. In particular, each head output can be assigned a weight, which is used for all values of the corresponding head output when forming the weighted sum.

The inventors found that the special design of the network with a backbone and the ensemble of heads advantageously increases the accuracy of the network. In addition, the requirement for computing capacity and memory is significantly lower in comparison to using a deep ensemble.

In various advantageous example embodiments of the present invention, it can further be provided that the output signal additionally comprises a value that characterizes an uncertainty with regard to the combination of the plurality of head outputs. If the head outputs of the plurality of head outputs characterize a classification relating to the presence or absence of objects, the uncertainty may, for example, characterize an uncertainty about the actual presence or absence of an object. If the head outputs of the plurality of head outputs characterize a prediction regarding the extension of an object, the uncertainty may characterize, for example, an uncertainty about the actual extension of the object. If the head outputs of the plurality of head outputs characterize a prediction regarding the position of an object, the uncertainty may characterize, for example, an uncertainty about the actual position of the object. Advantageously, the uncertainty can be used to indicate to a user of the neural network how trustworthy the neural network itself considers its output to be. This advantageously gives the user the option of intervening in the case of outputs that are associated with a high degree of uncertainty, in order to reduce or suppress possible incorrect behavior.

In particular, since the head outputs are typically in the form of a matrix or a tensor, the uncertainty can be ascertained with respect to each element or a subset of elements of the matrix or tensor. This plurality of uncertainties can then be provided in the output signal. This makes it possible in particular to indicate to the user of the neural network which uncertainty the object detection has ascertained for which region of the image.

The uncertainty can be expressed as a value ascertained using a predefined function. Mutual information can in particular be used as a function. Alternatively, other functions are also possible; for example, an entropy can be ascertained for each head output and a maximum entropy can be provided for each index position within the head outputs as an uncertainty value relating to the index position.

In further aspects of the present invention, a method is provided for ascertaining a control signal of an actuator or a display device based on an image, wherein the control signal is ascertained based on the output signal.

Advantageously, the actuator can be controlled better in this way since the output signal makes more accurate object detection possible.

In particular, according to an example embodiment of the present invention, the control signal can also be ascertained based on the ascertained uncertainty. For example, the drive signal can be selected such that a user of the device is prompted to take control of the actuator if the uncertainty relating to the combination of the plurality of head outputs reaches or exceeds a predefined threshold value. Advantageously, this can make the controlling of the actuator safer since decisions with high uncertainty and thus high potential for errors can be corrected by the user.

In a further aspect, the present invention relates to a device which is configured to perform the method for ascertaining the output signal or the control signal.

The device can be understood in particular as a computer or part of a computer.

Example embodiments of the present invention will be explained in detail below with reference to the figures.

### BRIEF DESCRIPTION OF THE DRAWINGS

FIG. 1 schematically shows a neural network at training time, according to an example embodiment of the present invention.

FIG. 2 schematically shows a training system for training the neural network, according to an example embodiment of the present invention.

FIG. 3 shows the neural network at inference time, according to an example embodiment of the present invention.

FIG. 4 schematically shows a structure of a control system for controlling an actuator, according to an example embodiment of the present invention.

FIG. 5 schematically shows an exemplary embodiment for controlling an at least partially autonomous robot, according to the present invention.

FIG. 6 schematically shows an exemplary embodiment for controlling a manufacturing system, according to the present invention.

FIG. 7 schematically shows an exemplary embodiment for controlling an access system, according to the present invention.

FIG. 8 schematically shows an exemplary embodiment for controlling a monitoring system, according to the present invention.

FIG. 9 schematically shows an exemplary embodiment for controlling a personal assistant, according to the present invention.

FIG. 10 schematically shows an exemplary embodiment for controlling a medical imaging system, according to the present invention.

### DETAILED DESCRIPTION OF EXAMPLE EMBODIMENTS

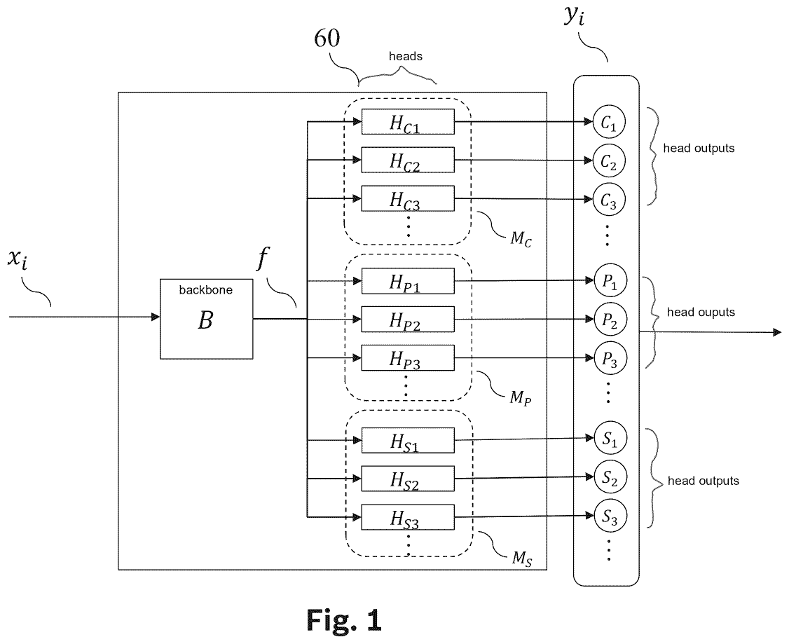

FIG. 1 shows a neural network (60), which is configured for training. The neural network (60) comprises a backbone (B), which in turn characterizes a neural network, for example a vision transformer. The backbone is designed to ascertain a feature representation (f) from a training image (xᵢ), which the neural network receives as input. This feature representation is transmitted to a plurality (M_{C}) of heads (H_{C1}, H_{C2}, H_{C3}) of the neural network (60) as input to the heads (H_{C1}, H_{C2}, H_{C3}). The heads (H_{C1}, H_{C2}, H_{C3}) are preferably each also neural networks, for example convolutional neural networks (CNN). In the exemplary embodiment, the heads are configured to ascertain the presence or absence of objects. For this purpose, the heads (H_{C1}, H_{C2}, H_{C3}) each ascertain head outputs (C₁, C₂, C₃) in the form of matrices whose elements correspond to regions of the training image (xᵢ). The receptive field of an element of the matrix defines the extension of the region within the training image (xᵢ). An element can then characterize whether or not an object is located within the region of the training image corresponding to it. Preferably, an element can indicate whether a center point of a bounding box that encloses the object lies within the region. The element can preferably be a real-valued number between 0 and 1 inclusive, which can be characterized as a probability for the presence of an object. Above a predefined threshold value, e.g., 0.5, an element can then be understood as indicating the presence of an object. In this case, values less than 0.5 characterize the absence of objects within the corresponding region. The threshold value can be understood as a hyperparameter of the neural network.

The head outputs (C₁, C₂, C₃) are provided during training as part of an output signal (yᵢ). Preferably, for ascertaining a more accurate position of the object (e.g., the center point of the bounding box), the neural network (60) comprises a further plurality (M_{P}) of heads (H_{P1}, H_{P2}, H_{P3}). The heads (H_{P1}, H_{P2}, H_{P3}) of this further plurality (M_{P}) ascertain further head outputs (P₁, P₂, P₃), which each characterize the exact position and are provided in the output signal (yᵢ).

Alternatively or additionally, for ascertaining an extension of the object (for example, width and height within the image), the neural network (60) comprises a further plurality (M_{S}) of heads (H_{S1}, H_{S2}, H_{S3}). The heads (H_{S1}, H_{S2}, H_{S3}) of this further plurality (M_{S}) ascertain further head outputs (S₁, S₂, S₃), which each characterize the exact position and are provided in the output signal (yᵢ).

In further exemplary embodiments (not shown), it can also be provided that the extension and position are in each case ascertained jointly by heads of a plurality of heads.

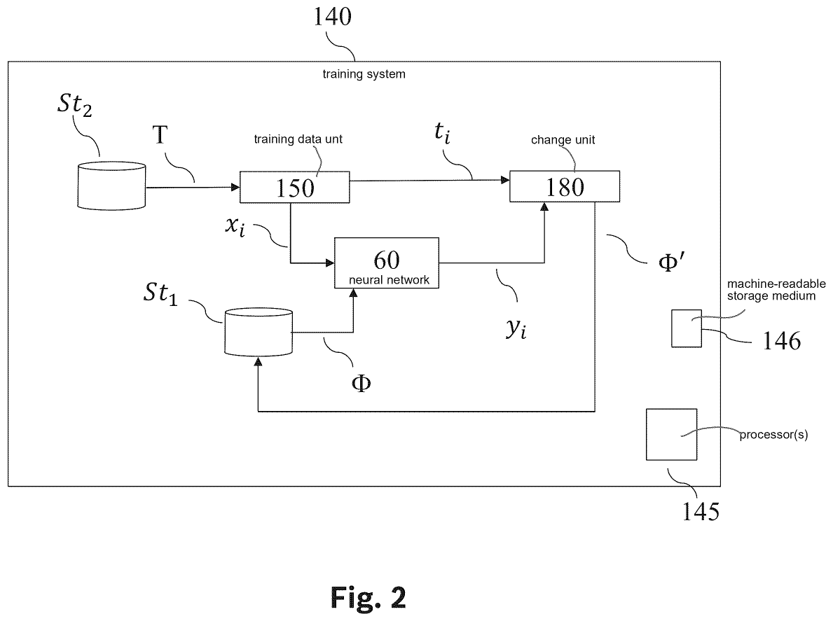

FIG. 2 shows an exemplary embodiment of a training system (140) for training the neural network (60) using a training data set (T). The training data set (T) comprises a plurality of training images (xᵢ) used to train the neural network (60), wherein the training data set (T) further comprises for each input image (xᵢ) a desired output signal (tᵢ), which corresponds to the input image (xᵢ) and which characterizes the presence or absence of objects within the training image (xᵢ) as well as their position and extension within the training image (xᵢ).

For the training, a training data unit (150) accesses a computer-implemented database (St₂), wherein the database (St₂) provides the training data set (T). The training data unit (150) ascertains from the training data set (T), preferably randomly, at least one training image (xᵢ) and the desired output signal (tᵢ) corresponding to the training image (xᵢ), and transmits the training image (xᵢ) to the neural network (60). The desired output signal (tᵢ) comprises at least one desired head output, for example a desired head output relating to the presence or absence of objects in the training image (xᵢ). Preferably, the desired output signal (tᵢ) comprises in each case a desired head output for the presence or absence of objects within the training image (xᵢ), for a position of objects within the training image (xᵢ) and for an extension of the objects within the training image (xᵢ). The neural network (60) ascertains an output signal (yᵢ) on the basis of the input image (xᵢ).

The desired output signal (tᵢ) and the ascertained output signal (yᵢ) are transmitted to a change unit (180).

On the basis of the desired output signal (tᵢ) and the ascertained output signal (yᵢ), the change unit (180) then determines new parameters (Φ′) for the neural network (60). For this purpose, the change unit (180) first ascertains a plurality of first loss values, wherein a loss value characterizes in each case a deviation of a head output (C₁, C₂, C₃, P₁, P₂, P₃, S₁, S₂, S₃) of the output signal (yᵢ) from a corresponding desired head output comprised by the desired output signal (tᵢ). A head output (C₁, C₂, C₃, P₁, P₂, P₃, S₁, S₂, S₃) corresponds to a desired head output if and only if the head output (C₁, C₂, C₃, P₁, P₂, P₃, S₁, S₂, S₃) describes the same property (i.e., either presence or absence, position, extension) as the desired head output. For example, if a head output characterizes the presence or absence of an object, this head output is compared with the desired head output for presence or absence.

In particular, the head outputs (C₁, C₂, C₃, P₁, P₂, P₃, S₁, S₂, S₃) comprised by the output signal (yᵢ) can each be present in the form of a matrix or a three-dimensional tensor, in which case the desired head output comprised by the desired output signal (tᵢ) is also present in the form of a matrix or a three-dimensional tensor. Along a height dimension and width dimension, the corresponding matrices or tensors each contain values or vectors that characterize a presence or absence, a position, or an extension. Values or vectors at equal indices along the height and width dimensions of a head output (C₁, C₂, C₃, P₁, P₂, P₃, S₁, S₂, S₃) and of a corresponding head output can then be compared using a loss function. The values thus ascertained can be accumulated by means of a mathematical operation; for example, they can be summed, summed in weighted fashion, or their maximum value can be ascertained. The result of the accumulation can then be provided as a first loss value relating to the head output (C₁, C₂, C₃, P₁, P₂, P₃, S₁, S₂, S₃).

The first loss values ascertained can then in turn be combined in order to ascertain a second loss value. Combining can again be done by a sum, a weighted sum, or by ascertaining the maximum of the first values. Preferably, it is also possible for the second loss value to be enriched by at least one regularization, for example an L₁ or L₂ normalization of parameters (Φ) of the neural network (60). Preferably, a negative correlation between the head output (C₁, C₂, C₃, P₁, P₂, P₃, S₁, S₂, S₃) can also be included as a regularization in the second loss value. For this purpose, an average value or average vector over the elements of the head outputs (C₁, C₂, C₃, P₁, P₂, P₃, S₁, S₂, S₃) along the height and width dimensions can in each case be ascertained first. A negative correlation can then be ascertained for each element, and the values thus ascertained can be combined to form a single negative correlation. These steps can be characterized in particular by the formula

$$nc ( {K}^{( 1 )} , … , {K}^{( N )} ) = - \frac{1}{NHW} {\sum }_{n = 1}^{N} {\sum }_{h = 1 , w = 1}^{H , W} {‖ {K}_{h , w}^{( n )} - \overline{{K}_{h , w}} ‖}_{2}^{2} ,$$

$$\overline{{K}_{h , w}} = \frac{1}{N} {\sum }_{n = 1}^{N} {K}_{h , w}^{( n )}$$

where K⁽¹⁾, . . . , K^{(N)} is the plurality of head outputs, N is the number of head outputs, H is the number of elements along the height dimension within a head output, W is the number of elements along the width dimension within a head output,

$${K}_{h , w}^{( n )}$$

is the element of the n-th head output at position h,w along the height or width dimension, and ∥⋅∥₂ is the Euclidean norm.

The second loss value can therefore be ascertained in particular based on the formula:

$$L 2 = \frac{1}{N} {\sum }_{n = 1}^{N} L {1}^{( n )} + λ \cdot nc ( {K}^{( 1 )} , … , {K}^{( N )} )$$

where L2 is the second loss value, L1⁽ⁿ⁾ is the n-th first loss value, and λ is a weighting coefficient of the regularization, wherein λ characterizes a hyperparameter of the training.

The change unit (180) ascertains the new parameters (Φ′) on the basis of the second loss value. In the exemplary embodiment, this is done using a gradient descent method, preferably Stochastic Gradient Descent, Adam, or AdamW. In further exemplary embodiments, the training can also be based on an evolutionary algorithm or second-order optimization.

The new parameters (Φ′) ascertained are stored in a model parameter memory (St₁). Preferably, the ascertained new parameters (Φ′) are provided as parameters (Φ) to the neural network (60).

In further, preferred exemplary embodiments, the described training is repeated iteratively for a predefined number of iteration steps or repeated iteratively until the first loss value falls below a predefined threshold value. Alternatively or additionally, it is also possible that the training is terminated when an average first loss value for a test or validation data set falls below a predefined threshold value. In at least one of the iterations, the new parameters (Φ′) ascertained in a previous iteration are used as parameters (Φ) of the neural network (60).

Furthermore, the training system (140) may comprise at least one processor (145) and at least one machine-readable storage medium (146) containing instructions that, when executed by the processor (145), cause the training system (140) to perform a training method according to one of the aspects of the present invention.

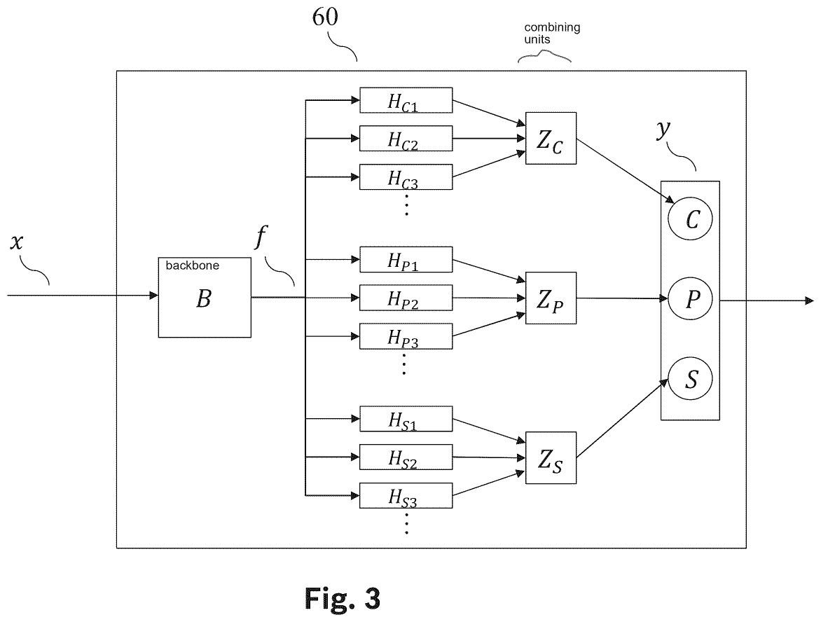

FIG. 3 shows how the neural network (60) can be used for object detection of objects of an input image (x) inference time. Preferably, parameters (Φ) of the neural network (60) are available in trained form. In other words, at inference time, the neural network (60) has already been trained.

Since what is desired at inference time is not a plurality of head outputs relating to presence or absence or position or extension, but only one head output each, the neural network (60) at inference time comprises a combining unit (Z_{C}, Z_{P}, Z_{S}), which combines the head outputs of the plurality of head outputs to form a single head output (C, P, S). In the exemplary embodiment, it is provided that presence or absence, position, and extension are in each case ascertained based on a corresponding plurality of head outputs. In this case, one combining unit (C, P, S) is provided per plurality of head outputs in the neural network (60). The correspondingly ascertained individual head outputs (C, P, S) are then provided in an output signal (y) by the neural network (60). In other exemplary embodiments (not shown), it can also be provided that bounding boxes are ascertained based on the individual head outputs (C, P, S) and that, instead of the head outputs (C, P, S) or in addition to the head outputs (C, P, S), the bounding boxes are provided in the output signal (y).

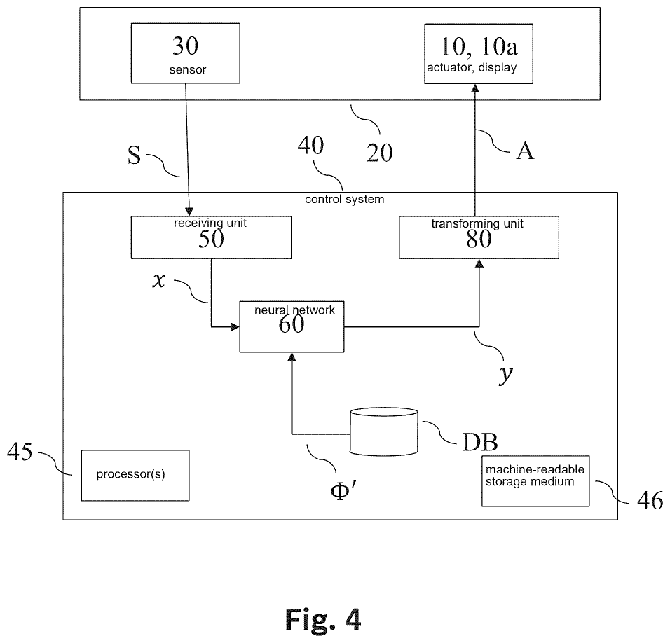

FIG. 4 shows a control system (40), which is designed to ascertain a control signal (A) of an actuator (10) based on the neural network (60). At preferably regular time intervals, the surrounding region (20) of the actuator (10) is detected in a sensor (30), in particular a camera sensor, which can also be provided by a plurality of camera sensors, for example a stereo camera. The sensor signal (S), or one sensor signal (S) each in the case of a plurality of sensors, of the sensor (30) is transmitted to the control system (40). The control system (40) thus receives a sequence of sensor signals (S). The control system (40) ascertains control signals (A) therefrom, which are transmitted to the actuator (10).

The control system (40) receives the sequence of sensor signals (S) of the sensor (30) in an optional receiving unit (50), which converts the sequence of sensor signals (S) into a sequence of input images (x) (alternatively, the sensor signal (S) can also be adopted directly as the input image (x) in each case). The input image (x) can, for example, be a portion or a further processing of the sensor signal (S). In other words, the input image (x) is ascertained depending on sensor signal (S). The sequence of input images (x) is fed to the neural network (60).

The neural network (60) is preferably parametrized by parameters (Φ) that are stored in a parameter memory (DB) and are provided by it.

From the input images (x), the neural network (60) ascertains output signals (y). The output signals (y) are fed to an optional transforming unit (80), which ascertains control signals (A) therefrom, which are fed to the actuator (10) in order to correspondingly control the actuator (10).

The actuator (10) receives the control signals (A), is controlled accordingly and performs a corresponding action. Here, the actuator (10) can comprise a control logic (not necessarily structurally integrated), which ascertains, from the control signal (A), a second control signal with which the actuator (10) is then controlled.

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) on which instructions are stored that, when executed on the at least one processor (45), cause the control system (40) to perform the method according to the present invention.

In alternative embodiments, a display device (10a) is provided as an alternative or in addition to the actuator (10). The display device (10a) can in particular be an optical display device, for example a screen. Alternatively, the display device (10a) can also be configured for other human senses. For example, it can be a loudspeaker or can indicate an event to a user via haptic signals such as vibration.

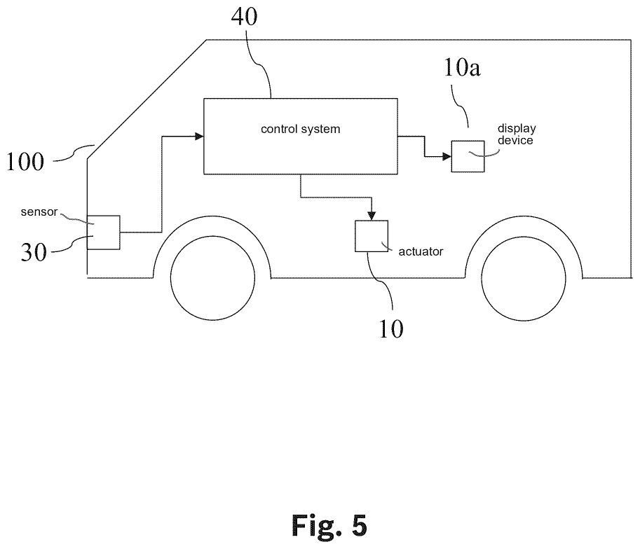

FIG. 5 shows how the control system (40) can be used to control an at least partially autonomous robot, here an at least partially autonomous motor vehicle (100).

The sensor (30) can, for example, be a camera sensor preferably arranged in the motor vehicle (100).

The neural network (60) is configured in the exemplary embodiment to identify recognizable objects, such as other vehicles, people, animals, or static objects such as traffic lights or houses, in the input images (x).

The actuator (10), which is preferably arranged in the motor vehicle (100), can, for example, be a brake, a drive, or a steering mechanism of the motor vehicle (100). The control signal (A) can then be ascertained in such a way that the actuator or actuators (10) are controlled in such a way that the motor vehicle (100), for example, prevents a collision with the objects identified by the neural network (60), in particular if the objects are of certain classes, e.g., pedestrians.

Alternatively or additionally, the display device (10a) can be controlled with the control signal (A). The display device can, for example, be a screen on which the identified objects are displayed. It is also possible for the display unit (10a) to be controlled with the control signal (A) in such a way that it outputs an optical or acoustic warning signal if it is ascertained that the motor vehicle (100) is in danger of colliding with one of the identified objects. The warning by means of a warning signal can also be provided by means of a haptic warning signal, for example by a vibration of a steering wheel of the motor vehicle (100).

Alternatively, the at least partially autonomous robot can be another mobile robot (not shown), for example one that moves by flying, swimming, diving or walking. The mobile robot can, for example, be an at least partially autonomous lawnmower or an at least partially autonomous cleaning robot. In these cases as well, the control signal (A) can be ascertained in such a way that the drive and/or steering system of the mobile robot are controlled in such a way that the at least partially autonomous robot prevents, for example, a collision with objects identified by the image neural network (60).

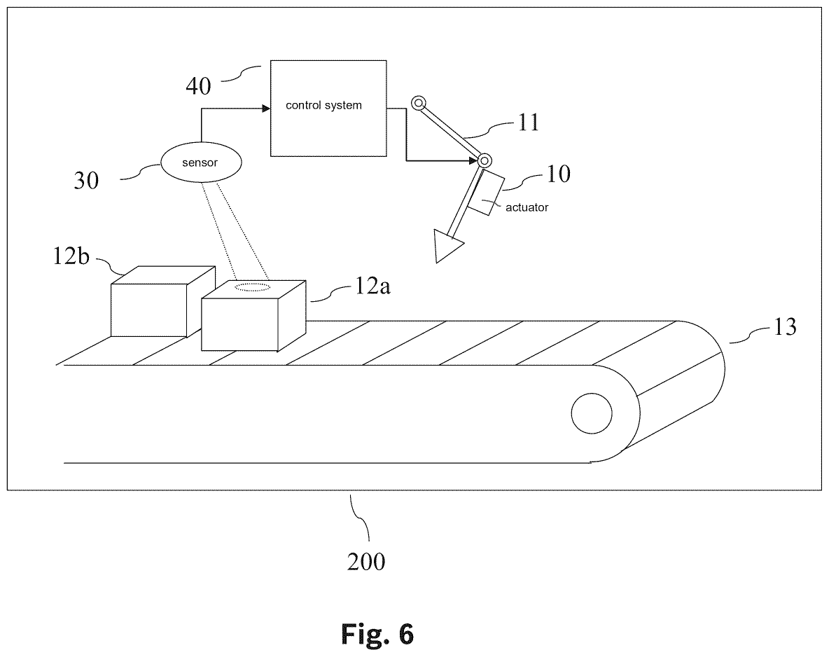

FIG. 6 shows an exemplary embodiment in which the control system (40) is used to control a manufacturing machine (11) of a manufacturing system (200) by controlling an actuator (10) that controls the manufacturing machine (11). The manufacturing machine (11) can, for example, be a machine for punching, sawing, drilling and/or cutting. Furthermore, it is possible that the manufacturing machine (11) is designed to grip a manufactured product (12a, 12b) by means of a gripper.

The sensor (30) can in this case, for example, be a video sensor which detects, for example, the conveying surface of a conveyor belt (13), wherein manufactured products (12a, 12b) can be located on the conveyor belt (13). The neural network (60) can for example be configured to detect the manufactured products (12a, 12b) on the conveyor belt and in particular to ascertain their position on the conveyor belt. The actuator (10) controlling the manufacturing machine (11) can then be controlled depending on the ascertained positions of the manufactured products (12a, 12b). For example, the actuator (10) can be controlled in such a way that it punches, saws, drills and/or cuts a manufactured product (12a, 12b) at a predetermined location on the manufactured product (12a, 12b).

Furthermore, it is possible that the neural network (60) is designed to ascertain further properties of a manufactured product (12a, 12b) alternatively or in addition to the position. In particular, it is possible that the neural network (60) ascertains whether a manufactured product (12a, 12b) is defective and/or damaged. In this case, the actuator (10) can be controlled in such a way that the manufacturing machine (11) rejects a defective and/or damaged manufactured product (12a, 12b).

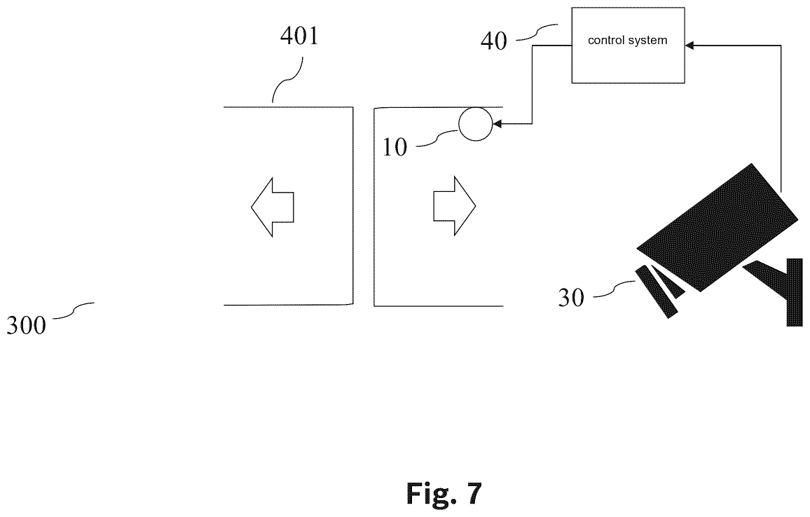

FIG. 7 shows an exemplary embodiment in which the control system (40) is used for controlling an access system (300). The access system (300) can comprise a physical access control, for example a door (401). The sensor (30) can in particular be a video sensor or thermal imaging sensor configured to detect a region in front of the door (401). A detected image can be interpreted by means of the neural network (60). In particular, the neural network (60) can detect persons in a transmitted input image (x). If a plurality of persons has been detected at the same time, the identity of the persons can, for example, be ascertained particularly reliably by assigning the persons (i.e., the objects) to one another, for example by analyzing their movements.

The actuator (10) can be a lock that, according to the control signal (A), releases the access control or not, for example opens the door (401) or not. For this purpose, the control signal (A) can be selected depending on the output signal (y) ascertained by the neural network (60) for the input image (x). For example, it is possible that the output signal (y) comprises information characterizing the identity of a person detected by the neural network (60), and the control signal (A) is selected based on the identity of the person.

Instead of physical access control, logical access control can also be provided.

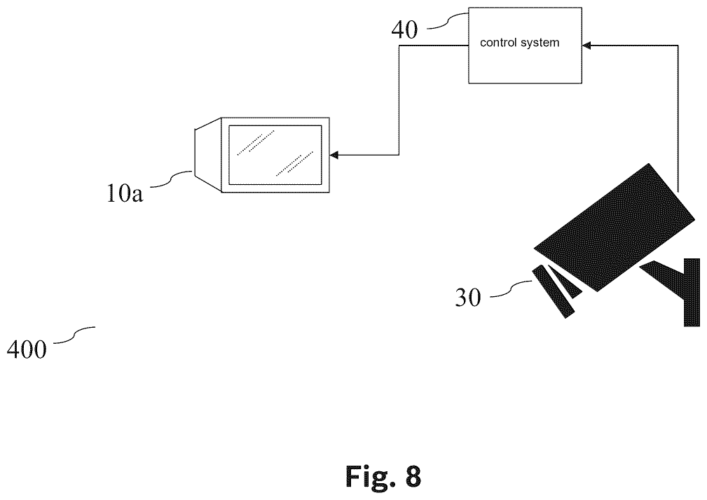

FIG. 8 shows an exemplary embodiment in which the control system (40) is used for controlling a monitoring system (400). This exemplary embodiment differs from the exemplary embodiment shown in FIG. 7 in that the display device (10a), which is controlled by the control system (40), is provided instead of the actuator (10). For example, the sensor (30) can record an input image (x) in which at least one person can be recognized, and the position of the at least one person is detected by means of the neural network (60). The input image (x) can then be displayed on the display device (10a), wherein the detected persons can be highlighted using color.

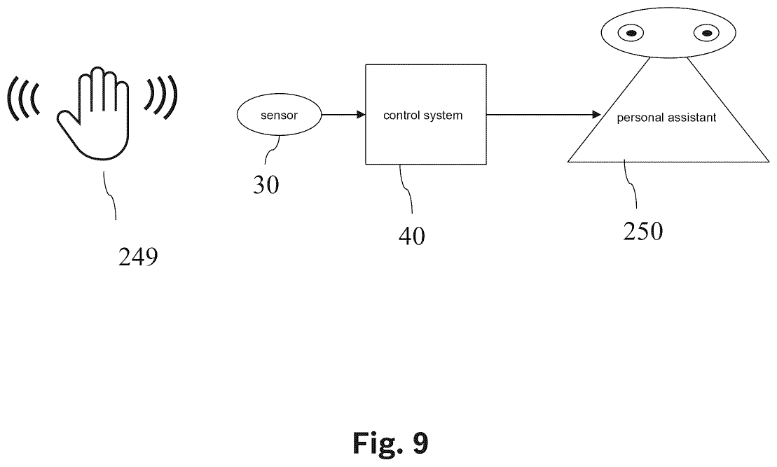

FIG. 9 shows an exemplary embodiment in which the control system (40) is used for controlling a personal assistant (250). The sensor (30) is preferably an optical sensor that receives images of a gesture of a user (249), for example a video sensor or a thermal imaging camera.

Depending on the signals from the sensor (30), the control system (40) ascertains a control signal (A) of the personal assistant (250), for example by the neural network (60) carrying out gesture recognition. This ascertained control signal (A) is then transmitted to the personal assistant (250), which is thus controlled accordingly. The ascertained control signal (A) can in particular be selected in such a way that it corresponds to a presumed desired controlling by the user (249). This presumed desired controlling can be ascertained depending on the gesture recognized by the neural network (60). The control system (40) can then, depending on the presumed desired controlling, select the control signal (A) for transmission to the personal assistant (250) and/or can select the control signal (A) for transmission to the personal assistant according to the presumed desired controlling (250).

This corresponding controlling can, for example, include the personal assistant (250) retrieving information from a database and reproducing it in a manner understandable by the user (249).

Instead of the personal assistant (250), a household appliance (not shown), in particular a washing machine, a stove, an oven, a microwave, or a dishwasher, can also be provided in order to be controlled accordingly.

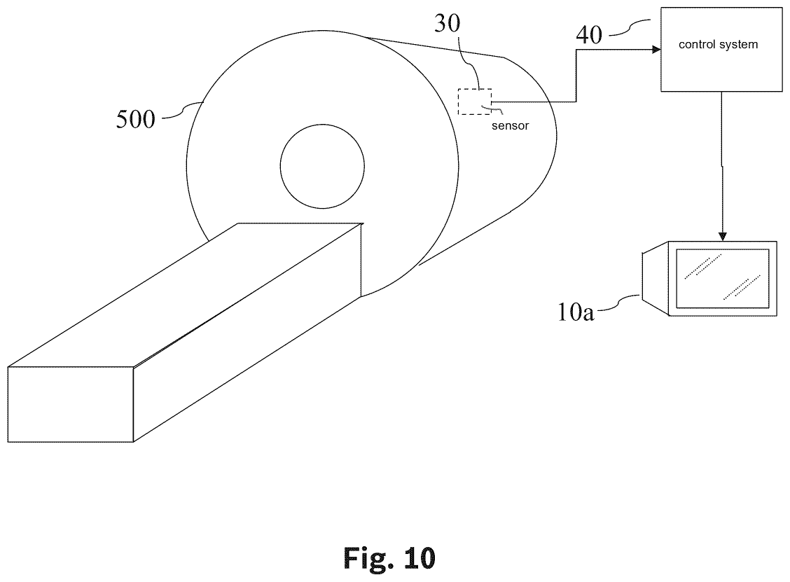

FIG. 10 shows an exemplary embodiment in which the control system (40) is used for controlling a medical imaging system (500), for example an MRI, X-ray or ultrasonic device. The sensor (30) can, for example, be an imaging sensor. The display device (10a) is controlled by the control system (40). The display device (10a) can in particular be provided by a screen.

The sensor (30) is configured to ascertain an image of a patient, for example an X-ray image, an MRI image, or an ultrasonic image. At least a part of the image is transmitted as an input image (x) to the neural network (60). The neural network (60) can, for example, be configured to detect different types of tissue to be recognized in the input image (x).

The control signal (A) can then be selected such that the ascertained types of tissue are highlighted using color on the display device (10a).

In further exemplary embodiments (not shown), the imaging system (500) can also be used for non-medical purposes, for example to ascertain material properties of a workpiece. For this purpose, the imaging system (500) can record an image of a workpiece. In this case, the neural network (60) can be configured in such a way that it receives at least a part of the image as an input image (x) and detects materials of the workpiece. The detection thus ascertained can, for example, be displayed together with the input image on the display device (10a).

The term “computer” includes any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-11. (canceled)

12. A computer-implemented method for training a neural network, wherein the neural network is configured to detect objects in images, and the training comprises the following steps:
ascertaining a feature representation of a training image using a backbone of the neural network;
ascertaining head outputs based on the feature representation and using means of a plurality of heads of the neural network, wherein the head outputs, for regions of the training image, each: (i) characterize a presence or absence of an object or (ii) characterize an extension of the object or (iii) characterize a position of the object or (iv) characterize the extension and the position;
ascertaining a plurality of first loss values, wherein each first loss value corresponds to a respective head output and characterizes a deviation of the respective head output from a desired head output; and
adjusting at least one parameter of the backbone and/or at least one parameter of a head of the plurality of heads, based on a second loss value, wherein the second loss value characterizes a sum of the first loss values.

13. The method according to claim 12, wherein the second loss value additionally characterizes a negative correlation between the head outputs.

14. The method according to claim 12, wherein the neural network includes a plurality of pluralities of heads and, for each plurality of heads, a second loss value is ascertained in each case and the neural network is trained based on a sum of the second loss values.

15. A method for ascertaining an output signal using a neural network, wherein the neural network is configured to detect objects in images, wherein the output signal characterizes presence or absence of objects within an image, wherein the method comprises the following steps:
ascertaining a feature representation of the image using the backbone of the neural network;
ascertaining a plurality of head outputs based on the feature representation and using the plurality of heads of the neural network;
ascertaining a combination of the plurality of head outputs to form one head output; and
ascertaining the output signal based on the one head output.

16. The method according to claim 15, wherein the method additionally comprises training the neural network by:
and is trained by:
ascertaining a feature representation of a training image using a backbone of the neural network,
ascertaining head outputs based on the feature representation and using means of a plurality of heads of the neural network, wherein the head outputs, for regions of the training image, each: (i) characterize a presence or absence of an object or (ii) characterize an extension of the object or (iii) characterize a position of the object or (iv) characterize the extension and the position,
ascertaining a plurality of first loss values, wherein each first loss value corresponds to a respective head output and characterizes a deviation of the respective head output from a desired head output, and
adjusting at least one parameter of the backbone and/or at least one parameter of a head of the plurality of heads, based on a second loss value, wherein the second loss value characterizes a sum of the first loss values.

17. The method according to claim 15, wherein the output signal additionally includes a value that characterizes an uncertainty relating to the combination of the plurality of head outputs.

18. The method according to claim 15, further comprising:
ascertaining a control signal based on the output signal, wherein the control signal is for actuating an actuator or a display device.

19. A device configured to ascertain an output signal using a neural network, wherein the neural network is configured to detect objects in images, wherein the output signal characterizes presence or absence of objects within an image, wherein the device is configured to:
ascertain a feature representation of the image using the backbone of the neural network;
ascertain a plurality of head outputs based on the feature representation and using the plurality of heads of the neural network;
ascertain a combination of the plurality of head outputs to form one head output; and
ascertain the output signal based on the one head output.

20. A training device configured to train a neural network, wherein the neural network is configured to detect objects in images, and the training device is configured to:
ascertain a feature representation of a training image using a backbone of the neural network;
ascertain head outputs based on the feature representation and using means of a plurality of heads of the neural network, wherein the head outputs, for regions of the training image, each: (i) characterize a presence or absence of an object or (ii) characterize an extension of the object or (iii) characterize a position of the object or (iv) characterize the extension and the position;
ascertain a plurality of first loss values, wherein each first loss value corresponds to a respective head output and characterizes a deviation of the respective head output from a desired head output; and
adjust at least one parameter of the backbone and/or at least one parameter of a head of the plurality of heads, based on a second loss value, wherein the second loss value characterizes a sum of the first loss values.

21. A non-transitory machine-readable storage medium on which is stored a computer program for training a neural network, wherein the neural network is configured to detect objects in images, and the computer program, when executed by a processor, causing the processor to perform the training by:
ascertaining a feature representation of a training image using a backbone of the neural network;
ascertaining head outputs based on the feature representation and using means of a plurality of heads of the neural network, wherein the head outputs, for regions of the training image, each: (i) characterize a presence or absence of an object or (ii) characterize an extension of the object or (iii) characterize a position of the object or (iv) characterize the extension and the position;
ascertaining a plurality of first loss values, wherein each first loss value corresponds to a respective head output and characterizes a deviation of the respective head output from a desired head output; and
adjusting at least one parameter of the backbone and/or at least one parameter of a head of the plurality of heads, based on a second loss value, wherein the second loss value characterizes a sum of the first loss values.
